(19) United States
(12) Patent Application Publication
(10) Pub. No.: US 2024/0284293 A1
(43) Pub. Date: Aug. 22, 2024

(54) UE BEHAVIOR IN CHO AND RLF CONDITIONAL TO A KNOWN TIME WHEN A CELL WILL STOP SERVING THE UE

(71) Applicant: Nokia Technologies Oy, Espoo (FI)

(72) Inventors: Rafhael MEDEIROS DE AMORIM, Aalborg (DK); Mads LAURIDSEN, Gistrup (DK); Jeroen WIGARD, Klarup (DK)

(73) Assignee: Nokia Technologies Oy, Espoo (FI)

(21) Appl. No.: 18/442,465

(22) Filed: Feb. 15, 2024

(30) Foreign Application Priority Data
Feb. 16, 2023 (FI) 20235183

(51) Int. Cl. H04W 36/36; H04W 36/24; H04W 36/30

(52) U.S. Cl. CPC H04W 36/362; H04W 36/249; H04W 36/305

(57) ABSTRACT

At a UE in wireless communication with a serving cell in a wireless network, the UE being configured with time-based conditional handover event trigger(s), receiving by the UE indication that the serving cell will be turning off. The UE determines relative timing of the time-based conditional handover event trigger(s) and timing based on the indication of the serving cell turning off. The UE determines whether the relative timing meets a criterion or criteria. The UE modifies, based on the relative timing meeting the criterion or criteria, mobility procedures for the UE that is in a connected state.

### TECHNICAL FIELD

Exemplary embodiments herein relate generally to wireless communications systems, and, more specifically, relates to wireless communications, such as non-terrestrial communications, where a cell will stop serving a UE (user equipment).

### BACKGROUND

In some wireless communication systems, devices (referred to a user equipment, UEs) connect to the systems in a coverage area of a cell. During certain times, such as for mobility (where the UE is moving), the UE has to perform a conditional handover (CHO), where the UE performs a handover from a current, serving cell to a target cell that is one of a number of previously determined candidate cells. This is conditional, as the handover is based on a number of conditions that have been configured for the UE by the system. The CHO may be performed in both terrestrial and non-terrestrial networks.

CHO can be specified for one or a group of cells and CHO can be performed similarly for a cell in a normal network as in a non-terrestrial network. CHO means the cell is prepared and the UE is prepared, so the UE executes the handover, once the conditions are fulfilled, and does not request for a handover. This is unlike a case with a normal handover, where the UE does request the handover.

Another example where a CHO is useful and can be configured is when a cell formed by a device such as a satellite in a non-terrestrial network will be turned off, although terrestrial cells may be turned off for other reasons, such as to save power. In these situations, the UE may be given advance notice that the current serving cell will be turned off, and perform a CHO. The processes for performing the CHOs in these situations could be improved.

### BRIEF SUMMARY

This section is intended to include examples and is not intended to be limiting.

In an exemplary embodiment, a method is disclosed that includes, at a user equipment in wireless communication with a serving cell in a wireless network, the user equipment being configured with one or more time-based conditional handover event triggers, receiving by the user equipment indication that the serving cell will be turning off. The method includes determining, by the user equipment, relative timing of the one or more time-based conditional handover event triggers and timing based on the indication of the serving cell turning off. The method further includes determining, by the user equipment, whether the relative timing meets one or more criteria, and modifying, by the user equipment based on the relative timing meeting the one or more criteria, mobility procedures for the user equipment that is in a connected state.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: at a user equipment in wireless communication with a serving cell in a wireless network, the user equipment being configured with one or more time-based conditional handover event triggers, receiving by the user equipment indication that the serving cell will be turning off; determining, by the user equipment, relative timing of the one or more time-based conditional handover event triggers and timing based on the indication of the serving cell turning off; determining, by the user equipment, whether the relative timing meets one or more criteria; and modifying, by the user equipment based on the relative timing meeting the one or more criteria, mobility procedures for the user equipment that is in a connected state.

An exemplary computer program product includes a computer-readable storage medium bearing instructions that, when executed by an apparatus, cause the apparatus to perform at least the following: at a user equipment in wireless communication with a serving cell in a wireless network, the user equipment being configured with one or more time-based conditional handover event triggers, receiving by the user equipment indication that the serving cell will be turning off; determining, by the user equipment, relative timing of the one or more time-based conditional handover event triggers and timing based on the indication of the serving cell turning off; determining, by the user equipment, whether the relative timing meets one or more criteria; and modifying, by the user equipment based on the relative timing meeting the one or more criteria, mobility procedures for the user equipment that is in a connected state.

In another exemplary embodiment, an apparatus comprises means for performing: at a user equipment in wireless communication with a serving cell in a wireless network, the user equipment being configured with one or more time-based conditional handover event triggers, receiving by the user equipment indication that the serving cell will be turning off; determining, by the user equipment, relative timing of the one or more time-based conditional handover event triggers and timing based on the indication of the serving cell turning off; determining, by the user equipment, whether the relative timing meets one or more criteria; and modifying, by the user equipment based on the relative timing meeting the one or more criteria, mobility procedures for the user equipment that is in a connected state.

### BRIEF DESCRIPTION OF THE DRAWINGS

In the attached drawings:

FIG. 1A is a block diagram of one possible and non-limiting exemplary system in which the exemplary embodiments may be practiced;

FIG. 1B is an example of a block diagram of an apparatus suitable for implementing any of the nodes in FIG. 1A;

FIG. 1C illustrates an example of some of the nodes from FIG. 1A in a quasi-earth-fixed cell arrangement for a particular architecture where a current serving cell will be turning off;

FIG. 1D illustrates the example of FIG. 1C using another possible architecture;

FIG. 2 illustrates a radio link failure detection process;

FIGS. 3A and 3B provide examples of the problem for a scenario as in FIG. 2, where FIG. 3A has the event t-service pointing for a point in time before both T1 and T2, whereas FIG. 3B shows T1 happening before t-service, but T2 is at a later point in time;

FIG. 4 is a logic flow diagram for a flowchart of how a UE may modify the course of action of RLF after reception of t-service; and

FIG. 5 is a logic flow diagram for a flowchart of a UE decision tree;

FIGS. 6A and 6B corresponding to FIGS. 3A and 3B, where FIG. 6A further describes step 2a of FIG. 5, and FIG. 6B further describes step 3a of FIG. 5.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”.

For any terms where there is a capital letter or a lowercase letter in the same locations, these should be considered to be the same. For example, CondEvent and condEvent are the same.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

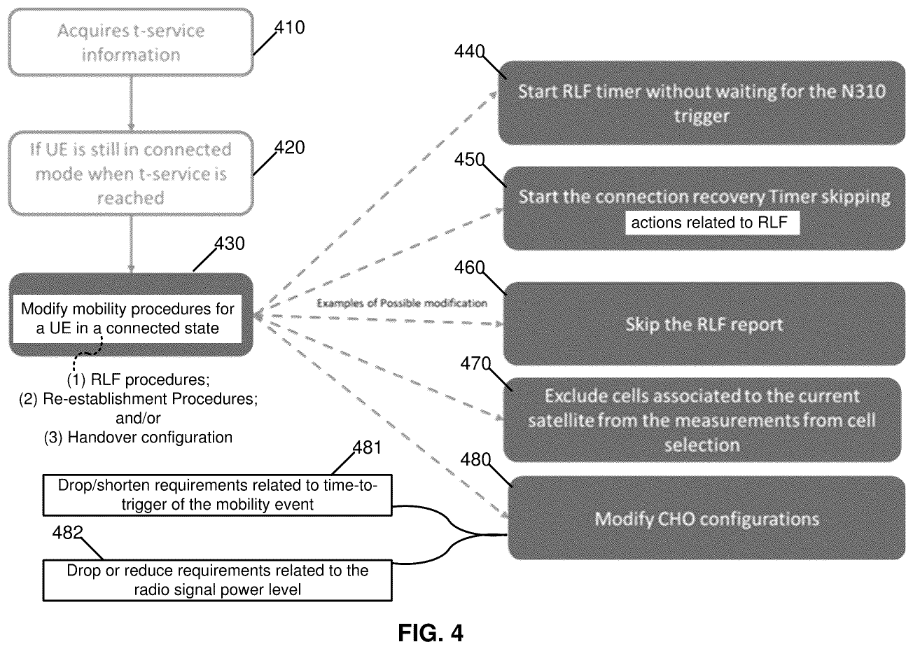

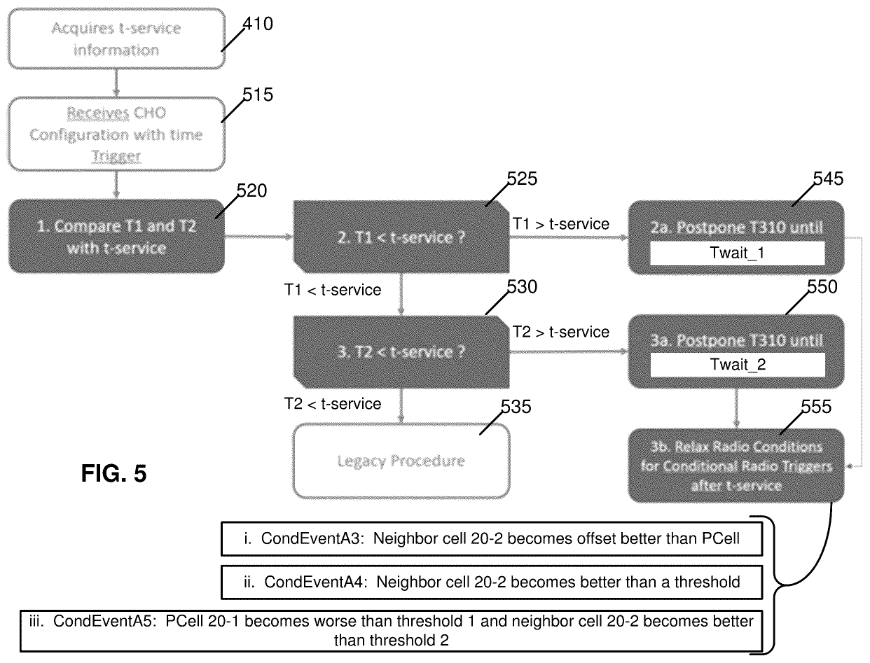

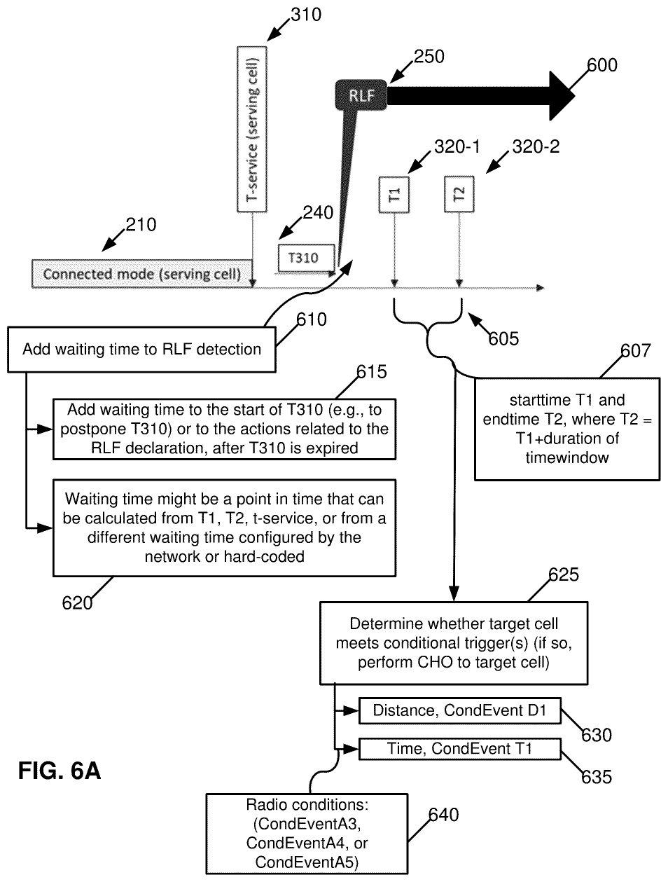

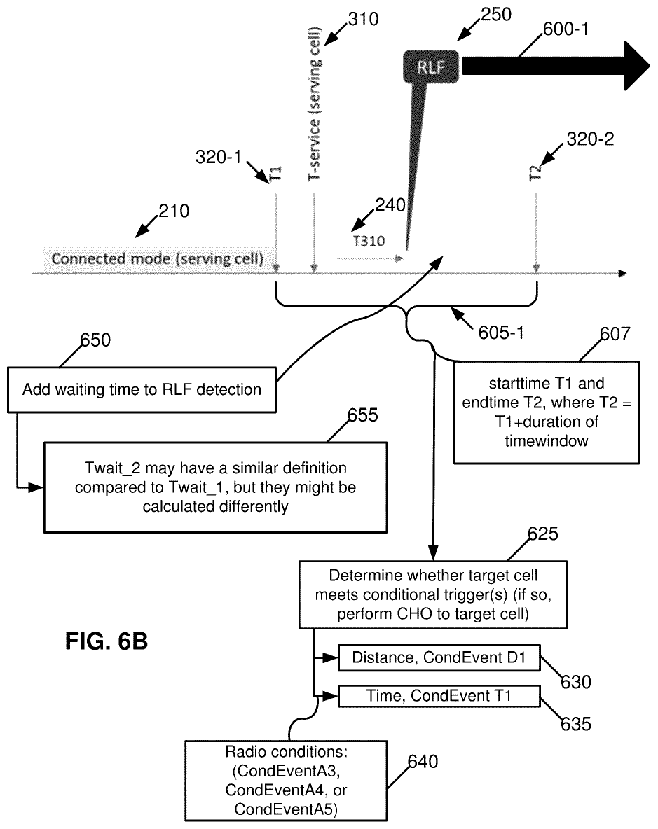

Any flow diagram (such as FIGS. 4 and 5) or signaling diagram herein is considered to be a logic flow diagram, and illustrates the operation of an exemplary method, results of execution of computer program instructions embodied on a computer readable memory, functions performed by logic implemented in hardware, and/or interconnected means for performing functions in accordance with an exemplary embodiment. Block diagrams (such as parts of FIGS. 6A and 6B) also illustrate the operation of an exemplary method, results of execution of computer program instructions embodied on a computer readable memory, functions performed by logic implemented in hardware, and/or interconnected means for performing functions in accordance with an exemplary embodiment.

The exemplary embodiments herein describe techniques for UE behavior in CHO and RLF conditional to a known time when a cell will stop serving the UE. Additional description of these techniques is presented after a system into which the exemplary embodiments may be used is described.

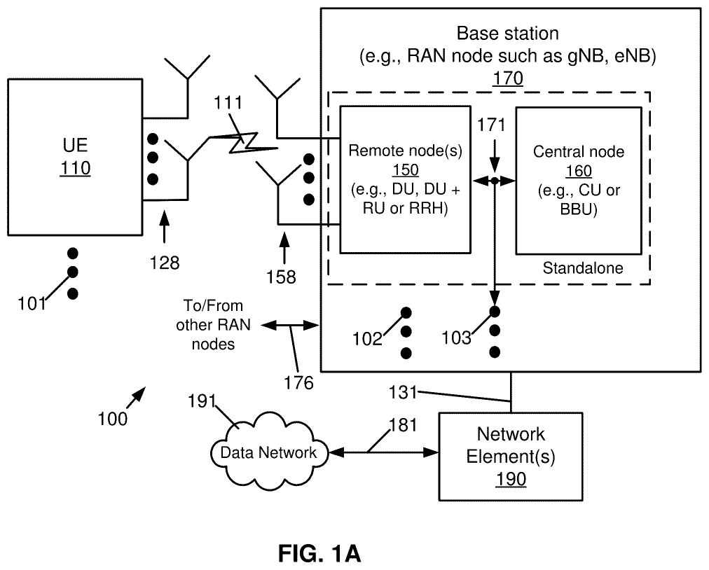

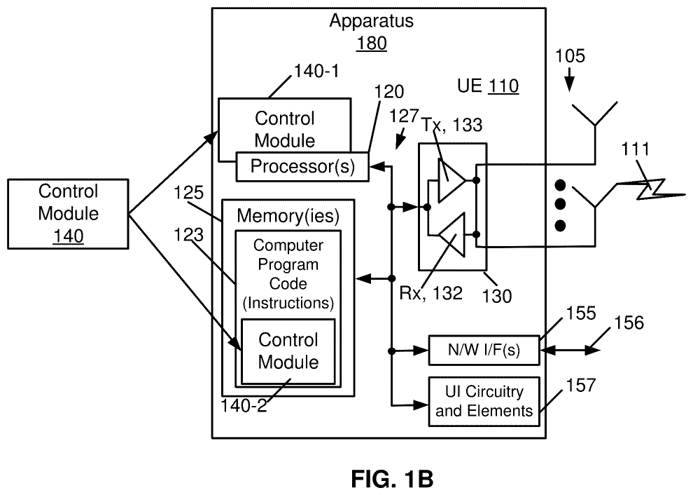

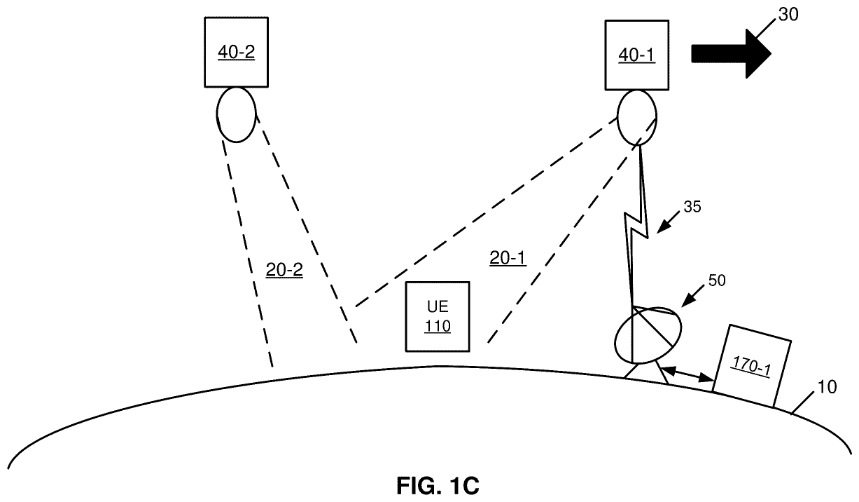

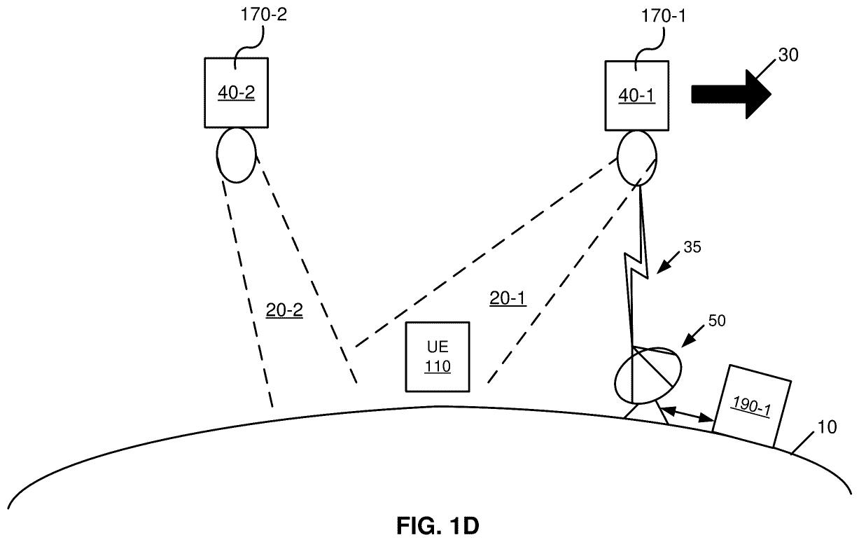

Turning to FIG. 1A, this figure shows a block diagram of one possible and non-limiting exemplary system in which the exemplary embodiments may be practiced. A number of nodes are shown: a user equipment (UE) 110; a base station 170; and network element(s) 190.

In FIG. 1A, a user equipment (UE) 110, as one of the nodes, is in wireless communication via wireless link 111 with a wireless network 100. A UE 110 is a wireless, typically mobile device that can access a wireless network. The UE 110 is illustrated with one or more antennas 128. The ellipses 101 indicate there could be multiple UEs 110.

The base station 170, as another of the nodes, provides access by wireless devices such as the UE 110 to the wireless network 100. The base station 170 is illustrated as having one or more antennas 158. There are many options for the base station 170. In general, the base station 170 is a RAN node, and in particular could be a gNB, which is the primary term used herein. That is, the base station 170 will be referred to as gNB 170. There are, however, many options including an eNB for the base station, or options other than cellular systems.

There are a number of configurations for the base station 170. One such is a “standalone” configuration, which includes all circuitry as part of a single unit, and accesses the antennas 158. More commonly today, circuitry is split into one or more remote nodes 150 (accessing antennas 158) and central nodes 160. For instance, for 5G (also referred to as NR), a gNB might include a distributed unit (DU), or DU and radio unit (RU) as the remote nodes(s), and a central unit (CU) as the central node 160. For LTE, the base station 170 might include an eNB having a remote radio head as remote node 150 and a base band unit (BBU) as a central node 160. The remote node(s) 150 are coupled to a central node 160 via one or more links 171. There could be multiple remote nodes 150 for a single central node 160, and this is indicated by ellipses 102, indicating multiple remote nodes, and ellipses 103, indicating additional links 171. The remote nodes 150 are remote in the sense they are contained in different physical enclosures from a physical enclosure containing a corresponding central node 160. The link(s) 171 may be implemented using fiber optics, wireless techniques, or any other technique for data communications.

Two or more base stations 170 communicate using, e.g., link(s) 176. The link(s) 176 may be wired or wireless or both and may implement, e.g., an Xn interface for 5G, an X2 interface for LTE, or other suitable interface for other standards.

The wireless network 100 may include a network element or elements 190, as a third illustrated node, that may include core network functionality, and which provide connectivity via a link or links 181 with a data network 191, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity) functionality and/or SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an SI interface for LTE, or other suitable interface for other standards.

It is noted that description herein indicates that “cells” perform functions, but it should be clear that the base station that forms the cell will perform the functions. The cell makes up part of a base station. That is, there can be multiple cells per base station. For instance, there could be three cells for a single carrier frequency and associated bandwidth, each cell covering one-third of a 360-degree area so that the single base station's coverage area covers an approximate oval or circle. Furthermore, each cell can correspond to a single carrier and a base station may use multiple carriers. So, if there are three 120-degree cells per carrier and two carriers, then the base station has a total of 6 cells.

In general, the various embodiments of the user equipment 110 can include, but are not limited to, cellular telephones (such as smart phones, mobile phones, cellular phones, voice over Internet Protocol (IP) (VOIP) phones, and/or wireless local loop phones), tablets, portable computers, vehicles or vehicle-mounted devices for, e.g., wireless V2X (vehicle-to-everything) communication, image capture devices such as digital cameras, gaming devices, music storage and playback appliances, Internet appliances (including Internet of Things, IoT, devices), IoT devices with sensors and/or actuators for, e.g., automation applications, as well as portable units or terminals that incorporate combinations of such functions, laptop-embedded equipment (LEE), laptop-mounted equipment (LME), Universal Serial Bus (USB) dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. That is, the UE 110 could be any end device that may be capable of wireless communication. By way of example rather than limitation, the UE may also be referred to as a communication device, terminal device (MT), a Subscriber Station (SS), a Portable Subscriber Station, a Mobile Station (MS), or an Access Terminal (AT).

Turning to FIG. 1B, this figure is an example of a block diagram of an apparatus 180 suitable for implementing any of the nodes in FIG. 1A. The apparatus 180 includes circuitry comprising one or more processors 120, one or more memories 125, one or more transceivers 130, one or more network (N/W) interface(s) (I/F(s)) 155 and user interface (UI) circuitry and elements 157, interconnected through one or more buses 127. Since this is an example covering all of the nodes in FIG. 1A, some of the nodes may not have all of the circuitry. For example, a base station 170 might not have UI circuitry and elements 157. All of the nodes may have additional circuitry, not described here. FIG. 1B is presented merely as an example.

Each of the one or more transceivers 130 includes a receiver, Rx, 132 and a transmitter, Tx, 133. The one or more buses 127 may be address, data, and/or control buses, and may include any interconnection mechanism, such as a series of lines on a motherboard or integrated circuit, fiber optics or other optical communication equipment, and the like. The one or more transceivers 130 are connected to one or more antennas 105, which could be one of the antennas 128 (from UE 110) or antennas 158 (from base station 170), and may communicate using wireless link 111.

The one or more memories 125 include computer program code 123. The apparatus 180 includes a control module 140, comprising one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code (having corresponding instructions) 123 and is executed by the one or more processors 120. For instance, the one or more memories 125 store instructions that, when executed by the one or more processors 120, cause the apparatus 180 to perform one or more of the operations as described herein. Furthermore, the one or more processors 120, one or more memories 125, and example algorithms (e.g., as flowcharts and/or signaling diagrams), encoded as instructions, programs, or code, are means for causing performance of the operations described herein.

The network interface(s) (N/W I/F(s)) 155 are wired interfaces communicating using link(s) 156, which could be fiber optic or other wired interfaces. The link(s) 156 could be the link(s) 131 and/or 176 from FIG. 1A. The link(s) 131 and/or 176 from FIG. 1A could also be implements using transceiver(s) 130 and corresponding wireless link(s) 111. The apparatus could include only wireless transceiver(s) 130, only N/W I/Fs 155, or both wireless transceiver(s) 130 and N/W I/Fs 155.

The apparatus 180 may or may not include UI circuitry and elements 157. These could include a display such as a touchscreen, speakers, or interface elements such as for headsets. For instance, a UE 110 of a smartphone would typically include at least a touchscreen and speakers. The UI circuitry and elements 157 may also include circuitry to communicate with external UI elements (not shown) such as displays, keyboards, mice, headsets, and the like.

The computer readable memories 125 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 125 may be means for performing storage functions. The processors 120 may be of any type suitable to the local technical environment, and may include one or more of general-purpose computers, special purpose computers, microprocessors, digital signal processors (DSPs) and processors based on a multi-core processor architecture, as non-limiting examples. The processors 120 may be means for performing functions, such as controlling the apparatus 180, and other functions as described herein.

Turning to FIG. 1C, this figure illustrates an example of some of the nodes from FIG. 1A in a quasi-earth-fixed cell arrangement where a current serving cell 20-1 (commonly referred to as a primary cell or PCell) will be turning off. In this figure, the UE 110 is in the coverage area of cell 20-1, which is a current serving cell that is produced by a LEO (low-earth orbit) satellite 40-1, and the earth surface 10 is illustrated. This LEO satellite 40-1 is in a quasi-earth-fixed cell orbit, but is moving as shown by arrow 30. Another LEO satellite 40-2 is shown. In further detail, an orbit may be the same for both earth-fixed and earth-moving cells. The difference is in how the satellite steers the beams (thereby projecting the cells on earth). In the earth-fixed cell case, the satellite is continuously adjusting the beam pointing such that the cell remains fixed on earth for a period of time (until the satellite is so low on the horizon that it is no longer feasible, i.e., t-service—described below—is reached). In the earth-moving cell case, the satellite has a fixed beam orientation (sometimes referred to as satellite-fixed cells), which means the cells sweep the earth as the satellite moves relative to the earth. The LEO satellite 40-1 is connected to the base station (e.g., gNB) 170-1 via an NTN gateway 50 (e.g., a satellite dish and hardware) via link 35. The LEO satellite 40-1 and the NTN gateway 50 could be considered to be a remote radio unit. This architecture is referred to as being transparent, because the satellite is essentially a relay/amplify-and-forward type of device.

The LEO satellite 40-1 gives advance warning to the UE 110 that the cell 20-1 will be turned off in the future, e.g., using a parameter referred to as “t-service”. The UE then has an opportunity to find another cell, such as cell 20-2 from LEO satellite 40-2, which could communicate with NTN gateway 50 and base station 170-1, or with a different NTN gateway 50 and/or base station 170 (not shown in this figure). The cell 20-2 is a neighbor cell that may be a candidate cell (e.g., of multiple candidate cells), and can be a target cell, e.g., once a CHO is determined to be made to the cell 20-2.

Another possible architecture is regenerative architecture where the base station is on board the satellite. This is illustrated by FIG. 1D, which illustrates the example of FIG. 1C using another possible architecture. In this architecture, a base station 170-1 is contained in the satellite 40-1, a base station 170-2 is contained in the satellite 40-2, and the NTN gateway 50 communicates with a network element 190-1. The satellite 40-2 and its base station 170-2 may communicate with the NTN gateway 50 or another such gateway (not shown).

Having thus introduced one suitable but non-limiting technical context for the practice of the exemplary embodiments, the exemplary embodiments will now be described with greater specificity.

The embodiments herein concern at least in part, e.g., support of NR and non-terrestrial networks in 3GPP release 18.

Release 18 provides further enhancements to the NTN specified in release 17. Both releases target transparent payloads (gNB/eNB on Earth relayed via a satellite to the NTN-capable UE) using either (quasi) earth-fixed or earth-moving cells. TS 38.300 defines the cells as follows (between the opening and closing quotes):

“Three types of service links are supported:
Earth-fixed: provisioned by beam(s) continuously covering the same graphical areas all the time (e.g., the case of GSO satellites);
Quasi-Earth-fixed: provisioned by beam(s) covering one geographic [symbol] for a limited period and a different geographic area during another period (e.g., the case [symbol] NGSO satellites generating steerable beams);
Earth-moving: provisioned by beam(s) whose coverage area slides [symbol] r the Earth surface (e.g., the case of NGSO satellites generating fixed or non-steerable [symbol] ms).”

Embodiments herein relate at least in part to three aspects of the NTN operation: switch off of serving satellite; conditional handover; and service continuity (e.g., radio link failure prevention). These aspects are introduced below.

### A) Switch Off of Serving Satellite

In release 17, it was specified that the quasi-earth-fixed cell will broadcast a parameter referred to as “t-service’ (in SIB19 for NR and SIB3 for IoT), which defines when the cell will stop serving the area it is currently serving. The t-service parameter is defined using TimeOffsetUTC, which refers to the offset in time from Monday 00:00:00 UTC in seconds. The UE knows that, after receiving the t-service, the signal related to this cell will no longer be transmitted (the satellite will “switch off” the radio footprint associated to this cell).

### B) Conditional Handover in NTN

In the NTN work, further conditional handover (CHO) configurations were investigated and specified in Rel-17 (NR) and Rel-18 (eMTC). This work has created two additional conditional triggers that may be combined with the conditional radio events CondEventA3, CondEventA4, CondEventA5:

### “TS 38.331, —ReportConfigNR:

CondEvent D1: Distance between UE and a reference location referenceLocation1 becomes larger than configured threshold distanceThreshFromReference1 and distance between UE and a reference location referenceLocation2 of conditional reconfiguration candidate becomes shorter than configured threshold distanceThreshFromReference2;
CondEvent T1: Time measured at UE becomes more than configured threshold t1-Threshold but is less than t1-Threshold+duration;”

When either the time or distance trigger is added to the conditional handover configuration, the UE must observe that this condition is triggered together with the radio condition before executing the handover. For example, if the time condition is configured, the UE will execute the handover if the radio conditions are met (CondEventA3, CondEventA4, or CondEventA5) for a target cell within the time window defined through starttime T1 and endtime T2, where T2=T1+duration of timewindow.

### C) RL Failures

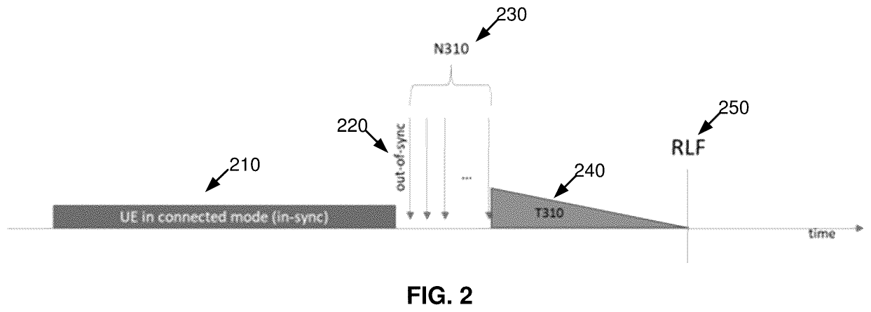

The process for declaring RLF happens as depicted in FIG. 2. A UE in connected mode (reference 210, where it is in-sync with a network), receives out-of-sync information 220 from lower layers upon detection of problems in the radio link. The counter N310 (reference 230) is incremented for each (consecutive) time an out-of-sync is received, and the counter is reset if an in-sync information is received from lower layers. When N310 reaches its configured maximum value, the UE starts the timer T310. The running of timer T310 is indicated by reference 240. If T310 expires before the UE has been capable of recovering the radio link (i.e., obtaining N311 in-sync indications), the UE detects a radio link failure (RLF) in reference 250. In more detail, the threshold N311 is used by the UE to determine if it can consider itself “in-sync” again. Thus, when the T310 is started (upon UE detecting N310 consecutive out-of-sync indications), the UE will start monitoring for in-sync indications. If the UE detects N311 consecutive in-sync indications, the UE can stop the T310 and go back to monitor out-of-sync indications. Thus, N311 is an indicator that the UE is considered to have recovered from the radio link issues. The N311 is network-configured, as are T310, N310, and T311.

If the UE is in connected mode with a DRB configured, the UE, upon detecting an RLF, will attempt to report the RLF in UL, including the RLF cause and the best measurement(s) available for all configured measurement objects. After this attempt, the UE starts T316 (if configured), which is a connection recovery timer, and if this timer expires before the UE receives a response from the gNB, the UE will initiate the re-establishment process.

The “out-of-sync” indications 220 that increment the counter N310 arrive from lower layers when quality of the signal falls below a certain threshold, see section 8.1.6, “Minimum requirement for LI indication”, 3GPP TS 38.133 V17.7.0 (2022 September):

“When the downlink radio link quality on all the configured RLM-RS resources is worse than Qₒᵤₜ, layer 1 of the UE shall send an out-of-sync indication for the cell to the higher layers. A layer 3 filter shall be applied to the out-of-sync indications as specified in TS 38.331 [2].”

### D) Re-Establishment

There are two procedures for the RRC re-establishment process that are relevant.
1. When the UE is not configured with attemptCondReconfig. In this case, the UE resets the MAC and suspends all data channels, including HO configurations and initiates a cell selection procedure.
2. When the UE is configured with attemptCondReconfig. In this case, the UE does not reset the MAC and does not suspend all data bearers before the cell selection procedure. The UE first performs the cell selection as in the case above (D.1). However, if the selected cell is on the configured set for conditional handover, the UE applies the conditional handover configuration, as long as CondEventT1 is not configured or is configured but the time window has not elapsed. Otherwise, the UE will reset MAC and suspend data bearers after the cell selection. The next paragraphs are applicable and from the cited TS (between the quotation marks):
“TS 38.331—5.3.7.3 Actions following cell selection while T311 is running
1> if attemptCondReconfig is configured; and
1> if the selected cell is not configured with CondEventT1, or the selected cell is configured with CondEventT1 and leaving condition has not been fulfilled; and
1> if the selected cell is one of the candidate cells for which the reconfigurationWithSync is included in the masterCellGroup in the MCG VarConditionalReconfig:
2> if the UE supports RLF-Report for conditional handover, set the choCellId in the VarRLF-Report to the global cell identity, if available, otherwise to the physical cell identity and carrier frequency of the selected cell;
2> apply the stored condRRCReconfig associated to the selected cell and perform actions as specified in 5.3.5.3;

NOTE 1: It is left to network implementation to how to avoid keystream reuse in case of CHO based recovery after a failed handover without key change.
1> else:
2> if UE is configured with attemptCondReconfig:
3> reset MAC;
3> release spCellConfig, if configured;
3> release the MCG SCell(s), if configured;”

### E) Additional Background Information

Note that for IoT NTN, the SIB32 defines a related parameter t-serviceStart, which defines when the next cell will serve the same area. This SIB32 contains satellite assistance information for prediction of discontinuous coverage.

Currently, it is known that after t-service, no coverage is expected from the current (e.g., quasi-earth fixed) serving cell (that is, the cell is switched off). This might lead to RLF being triggered, as the counter N310 will be incremented.

Due to the dynamicity of NTN scenarios involving non-geo-stationary satellites (NGSOs), this trigger for RLF might limit the possibilities for network configuration, especially considering that due to the large RTT, there is a high latency to set up a new initial connection after an RLF is triggered.

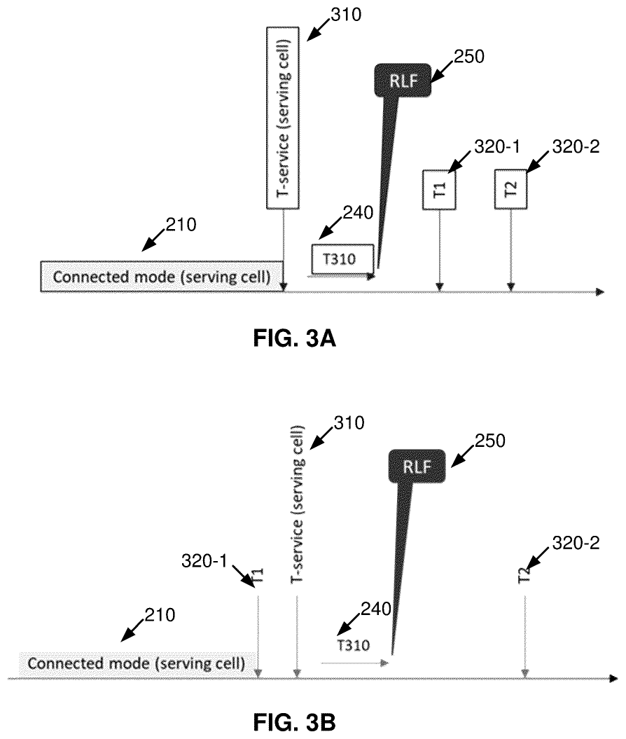

One example of this limitation is described on the scenario depicted in FIG. 2. The coverage provided by an incoming satellite, in the example scenario, might not have significant overlap in time with the coverage provided by the current cell (overlap in coverage before t-service). In this case, T1 and/or T2 (the time window for the CHO) might be defined to start after t-service, as shown in FIG. 3A. FIG. 3A has the event t-service 310 pointing for a point in time before both T1 320-1 and T2 320-2. The t-service 310 is an indication that the serving cell will be turning off.

In this case, the UE will not trigger a handover before t-service 310, because T1 320-1 starts later. And as the coverage is absent after t-service 310, it is likely that a RLF, detected in 250, will be triggered before the CHO is performed. Observe that the coverage from the target cell might be available some time before or rightly after t-service 310, depending on the satellite constellation and network configuration.

Not only does this limit the configurable time window for CHO, it might also cause undesirable RLF when the UE would be capable of completing a CHO shortly after t-service. The problem is further aggravated for eMTC cases, where the long DRX settings might limit the scope in time in which the UE may detect the incoming cell to finalize the CHO execution.

In the scenario in FIG. 3B, the CHO window has started before t-service 310 (as the T1 320-1 has occurred), but the radio conditions were not yet met when t-service is reached (or the UE was not able to fully detect the new cell). This causes the RLF to be detected in 250 prior to the T2 320-2. Monitoring for the serving cell is unnecessary, as the UE could focus on getting more measurements to the target cell, thereby possibly enabling the CHO execution before a RLF is detected and declared (reference 250).

This issue may be summarized as follows. After t-service, the UE 110 might experience for the N310 counter to be exceeded—which will unequivocally happen in certain scenarios—and for T310 (and T316, if configured) to be expired. This may delay considerably the continuity of the service and use unnecessary energy from the UE, as it needs to monitor the source serving cell throughout all this procedure, despite the t-service indicating the serving cell is no longer there. The waste of energy by the UE goes against the principles of NTN (supposedly used to connect remote areas with poor infrastructure) and against the emerging principle of green networks.

To address this issue and other issues, examples herein define new UE behaviors related to the t-service. And these behaviors may be conditional to the point in times corresponding to T1 and/or T2, when CHO is configured on the UE side.

It is noted that the main examples concern NTNs, e.g., using the t-service parameter. However, the techniques can apply to any system where there is a serving cell that has a known time where the serving cell will stop serving the UE, and there is a known time dependence for handover to a target UE. The UE then can perform a handover to a target cell, e.g., assuming certain conditions are met. For example, for network energy saving, there may be a similar scenario as to the NTN scenario, where a serving cell will indicate it will power off (e.g., to save energy) and the UE is configured with a conditional handover to a target cell.

As an overview, one example procedure may proceed as follows.
I. The NW provides information about t-service to the UE.
II. If the UE is configured with t-service (as in (I) above), the UE might be allowed to modify the RLF procedure to save power, possibly skipping unnecessary steps. That is, because the serving cell is or will be off, the UE could at least, e.g., skip the radio link measurements on the serving cell after t-service (because the serving cell is no longer there) and potentially the T310 modification (as there is the dependency on the target cell such as when will it be available that could cause skipping the potential modification of T310).
III. If the UE is configured with a conditional handover with additional conditions (ex: condEventT1), the UE checks if T1 and/or T2 happens after t-service on the current serving cell.
IV. In the case of T1 being configured to a point after t-service, the UE modifies (e.g., pauses/skips/postpones the start) timer T310 that would happen after t-service. The UE may also perform the following.
a. The UE may further modify the RLF procedures adding a waiting time for RLF declaration. The waiting time might be added to the start of T310 or to the actions after the expiry of T310 (or T316, if configured).
b. If T1 happens after t-service, by a difference above X, the UE might skip this step and continue with a legacy configuration; where X is a configured threshold.
V. If T1 is configured to a point before t-service, but T2 is configured to a point after t-service:
a. The UE may further modify the RLF procedures adding a waiting time for RLF declaration. The waiting time might be added to the start of T310 or to the actions after the expiry of T310 (or T316, if configured).
b. The UE might automatically change some of the conditions associated to the radio trigger of the conditional handover, i.e., causing an early trigger of the conditional handover condition (condEventA3, condEventA4 or condEventA5). The relaxation of the measurements is further explained below.

Note that this behavior can be limited to only one candidate cell, which is the cell replacing the current serving cell in a quasi-earth-fixed cell scenario.

Furthermore, the UE may optimize its energy consumption during the time between t-service and T1, such as by avoiding measuring the serving cell, while ensuring measurements by focusing on the configuration for neighbor cell measurements are ready at T1.

Now that an overview has been provided, further details are provided. The examples are described mainly through two parts, the first part corresponding to FIG. 4, and the second part corresponding to FIG. 5. In the first part, the UE modifies the RLF action or the re-establishment actions if t-service is reached and the UE is in connected mode, as depicted in the flowchart of FIG. 4, which is a logic flow diagram for a flowchart of how a UE may modify the course of action of RLF after reception of t-service. FIG. 4 is performed by a UE 110, e.g., under control of a corresponding control module 140.

In block 410, the UE 110 acquires t-service information from the NW. Block 430 is performed in response to block 420, wherein the UE is still in (RRC) connected state when t-service is reached. In block 430, the mobility procedures for a UE in a connected state may be modified by the UE. Modification of such mobility procedures could include modification of one or more of (1) RLF procedures; (2) re-establishment procedures; and/or (3) handover configuration. Possible modifications might be left for network configuration or UE implementation, and they might be related to any of the following blocks 440-480.

In block 440, the UE may start the RLF timer (T310) without waiting for the N310 counter to be exceeded. Alternatively, the UE is allowed to increment the N310 counter, without actively performing physical layer measurements on the serving cell. This may be performed in order to conserve UE energy. This is an example of a modification of an RLF procedure.

In block 450, the UE may start the connection recovery timer (T316), by completely skipping the actions related to RLF, such as the counter N310, timer T310, and/or the RLF report. This is an example of a modification of a re-establishment procedure.

In block 460, the UE may skip the RLF report, as the UE has no expectation of cell coverage by the source cell after t-service. This is an example of a modification of an RLF procedure. This is an example of a modification of an RLF procedure.

In block 470, the UE may exclude the cells associated to the current satellite from the measurements for cell selection or from the monitoring during T316. This is an example of a modification of a re-establishment procedure and may involve one or more of the following.
a. In NTNs, UEs utilize the ephemeris information to calibrate their clocks and frequency offset to measure the cells, due to the large doppler. This means that the configuration used to measure neighbor satellites is different from serving cell satellites (this led to the inclusion of measurement gap in NTN for intra-frequency measurement across different satellites).
b. In this case, the UE might skip the configuration associated to the current serving cell, and the cells associated to the current satellite, and only monitor for the target cells according to the ephemeris information associated to the neighbor satellites.
c. This might be performed during the cell selection procedure, but also when expecting recovery information in DL.

In block 480, the UE may modify CHO configurations. This is an example of a modification of handover configuration. The following are possible examples.
a. In this case, for example, if the UE is capable of detecting a neighbor cell associated to a CHO configuration, but the radio event (e.g., condEventA3, condEventA4 or condEventA5) has not been fulfilled, the UE might relax the conditions to trigger an early handover. (See, e.g., block 555 of FIG. 5.)
b. For example, the UE might drop/shorten requirements related to time-to-trigger of the mobility event (where the time-to-trigger is the time the target cell received power has to be above a threshold before the handover is triggered). See block 481 of FIG. 4. In other example, the UE might drop or reduce the requirements related to the radio signal power level. See block 482 of FIG. 4.

In the second part, the UE configured with a CHO with additional triggers (time or distance) might perform the actions depicted in the flowchart in FIG. 5, which is a logic flow diagram for a flowchart of a UE decision tree. FIG. 5 is performed by a UE 110, e.g., under control of a corresponding control module 140. In block 410, the UE 110 acquires t-service information from the NW. In block 515, the UE receives CHO configuration with a time trigger or time triggers from the NW. It is noted that these time-based triggers are not only conditions themselves (defining when CHO can occur), they also have corresponding conditions (referred to as conditional triggers) to meet for CHO to occur, such as the target cell meeting radio conditions. In other words, the time-based triggers indicate a window of time in which the corresponding conditions should be met for CHO to occur. Then the UE proceeds to perform the following.

In block 520, also labeled as step 1, the UE 110 compares the times defined by T1 and T2 with the time defined by the t-service. In this stage, the UE might apply any conversion needed between the two set of information (e.g., from slot indication to absolute time, for example; or distance with predicted time of occurrence). It is noted that when time threshold T1 is met, the UE has entered the condition for this time-based event (i.e., the UE can perform the CHO as long as the corresponding condition(s) for handover are met). After T1 plus the duration determined for this event is met, the UE leaves this condition (i.e., the UE not allowed to complete CHO).

In block 525, also labeled as step 2, if T1 happens after t-service (T1>t-service), the UE proceeds to block 545 (step 2a), where the UE is allowed to add a (e.g., first) waiting time to the RLF detection. It is noted that the term “waiting time” is used herein to indicate a time some action will be postponed, but other terms could be used, such as threshold, wait time, or the like. These options are described in reference to FIG. 6A, which also corresponds to FIG. 3A. The arrow 600 indicates that the RLF procedure is (basically) being moved from the current location in this example toward or past the window 605, which is formed in the example of block 607 by starttime T1 and endtime T2, where T2=T1+duration of timewindow. That is, the T1 and duration can define T2. This is one example, and other examples are possible, such as T2 and a “negative” duration defining T1. As an overview, one or more radio link failure or re-establishment procedures (see block 430 of FIG. 4 and blocks 545 and 550 of FIG. 5) are modified in order to delay detection of a possible radio link failure 600 until a conditional handover can be considered according to one or more time-based conditional handover event triggers (see the window 605 and blocks 625-640, possibly modified by block 555 of FIG. 5). It is noted that the t-service 310 is an indication that the serving cell will be turning off. Note that other indications might be used, e.g., for a terrestrial network, such as a message indicating the serving cell will be turning off.

As long as the UE can determine when the CHO is allowed to occur, e.g., the window and its starting (or ending) time, then the UE will perform the CHO if condition(s) are met. It is further noted that the T1 and T2 from a CHO configuration indicate implicitly when the new (target) cell is available, and when T1 is after T-service, as it is in FIGS. 3A and 6A, it is known that there is a gap between T-service and T1, which naturally could trigger T310. In this situation, if T1 is after T-service (and this knowledge is known, as it is in the example of FIG. 6A) then the RLF procedure(s) needs to be modified (via moving further out as indicated by reference 600), such that RLF 250 is not detected (and triggered) while the new cell appears right after.

Block 610 indicates that waiting time may be added to RLF detection (illustrated by reference 250) as part of the RLF procedure. Any of the options below may be chosen, although block 545 of FIG. 5 postpones T310 until a first waiting time, Twait_1.
i. The waiting time might be added to the start of T310 (e.g., to postpone T310) or to the actions related to the RLF declaration, after T310 is expired. See block 615 of FIG. 6.
ii. The waiting time (Twait_1) might be a point in time that can be calculated from T1, T2, t-service or from a different waiting time configured by the network or hard-coded, e.g., in the specifications. See block 620 of FIG. 6.
iii. Examples include the following:
1. Twait_1=T1+10 s;
2. Twait_1=T2;
3. Twait_1=t-service+X, where X is a value configured by the network; or
4. Twait_1=min(T1+10 s, X).

It is noted that during this process, the UE is determining whether a target cell meets conditional trigger(s) in block 625, e.g., during the window 605. The conditional triggers can include one or both of distance, e.g., CondEvent D1, in block 630, or time, e.g., CondEvent T1, in block 635. In particular, for the distance, a time-based conditional handover event trigger may be defined as a distance-based condition to the serving cell, to a neighbor cell, or to both the serving and neighbor cell. This distance-based condition can be mapped by the user equipment to a point in time by using orbital information of a moving satellite, movement information of the user equipment, or both the orbital information and the movement information. The conditional trigger(s) can be met via radio conditions in block 640, which may include CondEventA3, CondEventA4, CondEventA5. It is noted that the UE can perform a CHO to target cell in response to the conditional trigger(s) being met.

Turning back to FIG. 5, in block 530 (step 3), if t1 happens before t-service (T1<t-service), but T2 happens after t-service (T2>t-service), the UE in block 550, step 3a, might add a (second) waiting time to the RLF procedure, particularly RLF detection (illustrated by reference 250), via the second waiting time, Twait_2 Block 550 assumes that T310 is postponed until the second waiting time, Twait_2, but this is only one example. Block 550 is described with reference to FIG. 6B, which corresponds to FIG. 3B. Arrow 600-1 indicates that the RLF procedure is being moved from the current location in this example further into or past the window 605-1. As an overview, one or more radio link failure or re-establishment procedures (see block 430 of FIG. 4 and blocks 545 and 550 of FIG. 5) are modified in order to delay detection of a possible radio link failure 600-1 until a conditional handover can be considered according to one or more time-based conditional handover event triggers (see the window 605-1 and blocks 625-640, possibly modified by block 555 of FIG. 5).

It is again noted that the T1 and T2 from a CHO configuration indicate implicitly when the new (target) cell is available, and when T1 is before t-service, but T2 is after T-service as it is in FIGS. 3B and 6B, it is known that there is a gap between T-service and T2, which naturally could trigger T310. In this situation, if T1 is before T-service and T2 is after T-service (and this knowledge is known, as it is in the example of FIG. 6B) then the RLF procedure(s) needs to be modified (via moving further out as indicated by reference 600-1), such that RLF 250 is not detected (and triggered) while the new cell appears right after.

In block 650, waiting time is added to the RLF detection (illustrated by reference 250). Block 655 indicates that the second waiting time Twait_2 may have a similar definition compared to the first wait time, Twait_1, but they might be calculated differently. For example, Twait_2 may have a different value and may for instance not use Twait=t-service+X, where X is a value configured.

Blocks 625-640 are the same as in FIG. 6A.

Returning to FIG. 5, in block 555 (step 3b), in order to facilitate the execution of the CHO after t-service (e.g., a preventive measure against RLF) the UE might relax the conditional handover conditions as follows. Note that this relaxes the conditions from initial conditions to relaxed conditions, where the relaxations result in lowered requirements for accessing the target cell. For example, before relaxation of conditions, the received power of the target cell should be better than, e.g., −80 dBm, but with the relaxed conditions they just have to be better than e.g. −90 dBm. Note that block 555 may be reached from block 545 or block 550. Note also that handover events and CHO triggering conditions are described in 3GPP TS 38.331 (see, e.g., 3GPP TS 38.331 V17.3.0 (2022 December)).

### i. CondEventA3: Neighbor Cell 20-2 Becomes Offset Better than PCell 20-1

If t-service has already been reached, there is no advantage in comparing the target (neighbor) cell 20-2 with the current serving cell 20-1. The UE can move to the target cell 20-2 as long as the UE finds a suitable radio measurement. Time to trigger conditions might also be skipped in this case. If T1 has already been elapsed, UE might execute the HO.

### ii. CondEventA4: Neighbor Cell 20-2 Becomes Better than a Threshold

If t-service has already been achieved, the UE should move away from the current serving cell as early as possible. Time to trigger conditions might be skipped in this case. If T1 has already been elapsed, UE might execute the HO.

### iii. CondEventA5: PCell 20-1 Becomes Worse than Threshold 1 and Neighbor Cell 20-2 Becomes Better than Threshold 2

If t-service has already been achieved, the UE should move away from the current serving cell as early as possible. The condition for the first cell is assumed to be reached immediately after t-service. Time to trigger conditions might be skipped in this case. If T1 has already been elapsed, UE might execute the HO.

Block 535 is reached when T1<t-service and T2<t-service, and the UE follows a legacy procedure (i.e., when the CHO window, i.e., T1:T2, occurs before t-service, the UE can attempt to perform the CHO in the window).

As an observation, in some cases, the relaxation of the CHO conditions might cause an immediate CHO after t-service, when t-service happens between T1 and T2. This is beneficial for the UE that is moving away from the serving cell and avoiding an unnecessary RLF.

In one embodiment, the UE may be mobile and move from the serving cell 20-1 to a neighbor cell 20-2. This means the CHO configuration for the target cell 20-2, which will provide coverage in the area of the current serving cell, is not applicable. Thus, if the UE detects that it is mobile (either based on GNSS or increasing RSRP of neighbor cells 20-2) the UE is not allowed to modify the RLF and RRC re-establishment procedures as otherwise outlined in FIG. 4. Instead, the UE shall follow the legacy procedures and attempt regular handover/cell reselection.

Without in any way limiting the scope, interpretation, or application of the claims appearing below, a technical effect and advantage of one or more of the example embodiments disclosed herein is that the UE does not declare RLF before the CHO window is reached, but instead adjusts the use of T310 (or related procedures) relative to the CHO window and t-service. This can reduce UE energy consumption and signaling between UE and BS.

The following are additional examples.

Example 1. A method, comprising:
at a user equipment in wireless communication with a serving cell in a wireless network, the user equipment being configured with one or more time-based conditional handover event triggers, receiving by the user equipment indication that the serving cell will be turning off;
determining, by the user equipment, relative timing of the one or more time-based conditional handover event triggers and timing based on the indication of the serving cell turning off;
determining, by the user equipment, whether the relative timing meets one or more criteria; and
modifying, by the user equipment based on the relative timing meeting the one or more criteria, mobility procedures for the user equipment that is in a connected state.

Example 2. The method according to example 1, wherein:
the one or more time-based conditional handover event triggers at least define a time window within which the handover from the serving cell to a target cell is allowed to occur; and
the determining whether the relative timing meets one or more criteria determines the relative timing meets the one or more criteria because a starting time of the time window is later than the timing based on the indication of the serving cell turning off.

Example 3. The method according to example 1, wherein:
the one or more time-based conditional handover event triggers at least define a time window within which the handover from the serving cell to a target cell is allowed to occur; and
the determining whether the relative timing meets one or more criteria determines the relative timing meets the one or more criteria because a starting time of the time window is earlier than the timing based on the indication of the serving cell turning off, and an ending time of the time window is later than the timing based on the indication of the serving cell turning off.

Example 4. The method according to one of examples 2 or 3, wherein modifying the mobility procedures for the user equipment that is in a connected state comprises adding a waiting time to when a radio link failure procedure for detection of a radio link failure is to be started so a start of the radio link failure procedure is delayed at least by the waiting time.

Example 5. The method according to example 4, wherein a waiting time defined for example 2 is different from a waiting time defined for example 3.

Example 6. The method according to any one of examples 4 or 5, wherein the waiting time comprises a time added to a start of a timer, the expiration of which indicates a radio link failure, or a time added to actions related to a radio link failure declaration, after the timer is expired.

Example 7. The method according to any one of examples 4 or 5, wherein the waiting time is a point in time that is calculated from a starting time of the time window, an ending time of the time window, or the timing based on the indication of the serving cell turning off, or is a time configured by the network or hard-coded.

Example 8. The method according to any one of examples 2 to 7, wherein one or more time-based conditional handover event triggers comprise a starting time of the time window and duration of the time window.

Example 9. The method according to any one of examples 1 to 8, wherein the one or more time-based conditional handover event triggers have corresponding conditional radio triggers used for conditional handover, and wherein the modifying the mobility procedures for the user equipment that is in a connected state comprises relaxing radio conditions from an initial condition to a relaxed condition for conditional radio triggers used after the timing based on the indication of the serving cell turning off has occurred.

Example 10. The method according to example 9, wherein the relaxing radio conditions comprise one of the following:
a first conditional handover condition is relaxed so that a neighbor cell is allowed to become an offset better in radio conditions than the serving cell in order to meet the first conditional handover condition;
a second conditional handover condition is relaxed so that a neighbor cell is allowed to become better in radio conditions than a threshold in order to meet the second conditional handover condition;
a third conditional handover condition is relaxed so that the serving cell is allowed to become worse than a first threshold and a neighbor cell is allowed to become better than a second threshold in order to meet the third conditional handover condition; or
dropping or shortening requirements related to time-to-trigger of a mobility event; or
dropping or reducing requirements related to a radio signal power level.

Example 11. The method according to any one of examples 1 to 10, wherein the modifying the mobility procedures for the user equipment that is in a connected state comprises one or more of the following:
starting a radio link failure timer without waiting for a trigger, indicating a number of times an out-of-synchronization indication has been received, to meet a maximum configured value;
starting a connection recover timer and skipping actions related to radio link failure;
skipping sending of a radio link failure report;
excluding one or more cells associated to a current satellite from measurements for cell selection for a conditional handover; or
modifying one or more conditional handover configurations used for the conditional handover.

Example 12. The method according to any one of examples 1 to 11, wherein the modifying the mobility procedures for the user equipment that is in a connected state is performed in order to delay detection of a possible radio link failure until a conditional handover can be considered according to the one or more time-based conditional handover event triggers.

Example 13. The method according to any one of examples 1 to 12, wherein the method is performed in one of a terrestrial network or a non-terrestrial network.

Example 14. The method according to any one of examples 1 to 13, wherein at least one time-based conditional handover event trigger is defined as a distance-based condition to the serving cell, to a neighbor cell, or to both the serving and neighbor cell that can be mapped by the user equipment to a point in time by using orbital information of a moving satellite, movement information of the user equipment, or both the orbital information and the movement information.

Example 15. The method according to any one of examples 1 to 14, wherein modifying the mobility procedures for the user equipment that is in the connected state comprises modifying one or more of the following: radio link failure procedures; re-establishment procedures; or handover configuration.

Example 16. A computer program, comprising instructions for performing the methods of any of examples 1 to 15, when the computer program is run on an apparatus.

Example 17. The computer program according to example 16, wherein the computer program is a computer program product comprising a computer-readable medium bearing instructions embodied therein for use with the apparatus.

Example 18. The computer program according to example 16, wherein the computer program is directly loadable into an internal memory of the apparatus.

Example 19. An apparatus, comprising means for performing:
at a user equipment in wireless communication with a serving cell in a wireless network, the user equipment being configured with one or more time-based conditional handover event triggers, receiving by the user equipment indication that the serving cell will be turning off;
determining, by the user equipment, relative timing of the one or more time-based conditional handover event triggers and timing based on the indication of the serving cell turning off;
determining, by the user equipment, whether the relative timing meets one or more criteria; and
modifying, by the user equipment based on the relative timing meeting the one or more criteria, mobility procedures for the user equipment that is in a connected state.

Example 20. The apparatus according to example 19, wherein:
the one or more time-based conditional handover event triggers at least define a time window within which the handover from the serving cell to a target cell is allowed to occur; and
the determining whether the relative timing meets one or more criteria determines the relative timing meets the one or more criteria because a starting time of the time window is later than the timing based on the indication of the serving cell turning off.

Example 21. The apparatus according to example 19, wherein:
the one or more time-based conditional handover event triggers at least define a time window within which the handover from the serving cell to a target cell is allowed to occur; and
the determining whether the relative timing meets one or more criteria determines the relative timing meets the one or more criteria because a starting time of the time window is earlier than the timing based on the indication of the serving cell turning off, and an ending time of the time window is later than the timing based on the indication of the serving cell turning off.

Example 22. The apparatus according to one of examples 20 or 21, wherein modifying the mobility procedures for the user equipment that is in a connected state comprises adding a waiting time to when a radio link failure procedure for detection of a radio link failure is to be started so a start of the radio link failure procedure is delayed at least by the waiting time.

Example 23. The apparatus according to example 22, wherein a waiting time defined for example 20 is different from a waiting time defined for example 21.

Example 24. The apparatus according to any one of examples 22 or 23, wherein the waiting time comprises a time added to a start of a timer, the expiration of which indicates a radio link failure, or a time added to actions related to a radio link failure declaration, after the timer is expired.

Example 25. The apparatus according to any one of examples 22 or 23, wherein the waiting time is a point in time that is calculated from a starting time of the time window, an ending time of the time window, or the timing based on the indication of the serving cell turning off, or is a time configured by the network or hard-coded.

Example 26. The apparatus according to any one of examples 20 to 25, wherein one or more time-based conditional handover event triggers comprise a starting time of the time window and duration of the time window.

Example 27. The apparatus according to any one of examples 19 to 26, wherein the one or more time-based conditional handover event triggers have corresponding conditional radio triggers used for conditional handover, and wherein the modifying the mobility procedures for the user equipment that is in a connected state comprises relaxing radio conditions from an initial condition to a relaxed condition for conditional radio triggers used after the timing based on the indication of the serving cell turning off has occurred.

Example 28. The apparatus according to example 27, wherein the relaxing radio conditions comprise one of the following:
a first conditional handover condition is relaxed so that a neighbor cell is allowed to become an offset better in radio conditions than the serving cell in order to meet the first conditional handover condition;
a second conditional handover condition is relaxed so that a neighbor cell is allowed to become better in radio conditions than a threshold in order to meet the second conditional handover condition;
a third conditional handover condition is relaxed so that the serving cell is allowed to become worse than a first threshold and a neighbor cell is allowed to become better than a second threshold in order to meet the third conditional handover condition; or
dropping or shortening requirements related to time-to-trigger of a mobility event; or
dropping or reducing requirements related to a radio signal power level.

Example 29. The apparatus according to any one of examples 19 to 28, wherein the modifying the mobility procedures for the user equipment that is in a connected state comprises one or more of the following:
starting a radio link failure timer without waiting for a trigger, indicating a number of times an out-of-synchronization indication has been received, to meet a maximum configured value;
starting a connection recover timer and skipping actions related to radio link failure;
skipping sending of a radio link failure report;
excluding one or more cells associated to a current satellite from measurements for cell selection for a conditional handover; or
modifying one or more conditional handover configurations used for the conditional handover.

Example 30. The apparatus according to any one of examples 19 to 29, wherein the modifying the mobility procedures for the user equipment that is in a connected state is performed in order to delay detection of a possible radio link failure until a conditional handover can be considered according to the one or more time-based conditional handover event triggers.

Example 31. The apparatus according to any one of examples 19 to 30, wherein the apparatus is performed in one of a terrestrial network or a non-terrestrial network.

Example 32. The apparatus according to any one of examples 19 to 31, wherein at least one time-based conditional handover event trigger is defined as a distance-based condition to the serving cell, to a neighbor cell, or to both the serving and neighbor cell that can be mapped by the user equipment to a point in time by using orbital information of a moving satellite, movement information of the user equipment, or both the orbital information and the movement information.

Example 33. The apparatus according to any one of examples 19 to 32, wherein modifying the mobility procedures for the user equipment that is in the connected state comprises modifying one or more of the following: radio link failure procedures; re-establishment procedures; or handover configuration.

Example 34. The apparatus of any preceding apparatus example, wherein the means comprises:
at least one processor; and
at least one memory storing instructions that, when executed by at least one processor, cause the performance of the apparatus.

Example 35. An apparatus, comprising:
one or more processors; and
one or more memories storing instructions that, when executed by the one or more processors, cause the apparatus at least to perform:
at a user equipment in wireless communication with a serving cell in a wireless network, the user equipment being configured with one or more time-based conditional handover event triggers, receiving by the user equipment indication that the serving cell will be turning off;
determining, by the user equipment, relative timing of the one or more time-based conditional handover event triggers and timing based on the indication of the serving cell turning off;
determining, by the user equipment, whether the relative timing meets one or more criteria; and
modifying, by the user equipment based on the relative timing meeting the one or more criteria, mobility procedures for the user equipment that is in a connected state.

Example 36. The apparatus according to example 35, wherein:
the one or more time-based conditional handover event triggers at least define a time window within which the handover from the serving cell to a target cell is allowed to occur; and
the determining whether the relative timing meets one or more criteria determines the relative timing meets the one or more criteria because a starting time of the time window is later than the timing based on the indication of the serving cell turning off.

Example 37. The apparatus according to example 35, wherein:
the one or more time-based conditional handover event triggers at least define a time window within which the handover from the serving cell to a target cell is allowed to occur; and
the determining whether the relative timing meets one or more criteria determines the relative timing meets the one or more criteria because a starting time of the time window is earlier than the timing based on the indication of the serving cell turning off, and an ending time of the time window is later than the timing based on the indication of the serving cell turning off.

Example 38. The apparatus according to one of examples 36 or 37, wherein modifying the mobility procedures for the user equipment that is in a connected state comprises adding a waiting time to when a radio link failure procedure for detection of a radio link failure is to be started so a start of the radio link failure procedure is delayed at least by the waiting time.

Example 39. The apparatus according to example 38, wherein a waiting time defined for example 36 is different from a waiting time defined for example 37.

Example 40. The apparatus according to any one of examples 38 or 39, wherein the waiting time comprises a time added to a start of a timer, the expiration of which indicates a radio link failure, or a time added to actions related to a radio link failure declaration, after the timer is expired.

Example 41. The apparatus according to any one of examples 38 or 39, wherein the waiting time is a point in time that is calculated from a starting time of the time window, an ending time of the time window, or the timing based on the indication of the serving cell turning off, or is a time configured by the network or hard-coded.

Example 42. The apparatus according to any one of examples 36 to 41, wherein one or more time-based conditional handover event triggers comprise a starting time of the time window and duration of the time window.

Example 43. The apparatus according to any one of examples 35 to 42, wherein the one or more time-based conditional handover event triggers have corresponding conditional radio triggers used for conditional handover, and wherein the modifying the mobility procedures for the user equipment that is in a connected state comprises relaxing radio conditions from an initial condition to a relaxed condition for conditional radio triggers used after the timing based on the indication of the serving cell turning off has occurred.

Example 44. The apparatus according to example 43, wherein the relaxing radio conditions comprise one of the following:
a first conditional handover condition is relaxed so that a neighbor cell is allowed to become an offset better in radio conditions than the serving cell in order to meet the first conditional handover condition;
a second conditional handover condition is relaxed so that a neighbor cell is allowed to become better in radio conditions than a threshold in order to meet the second conditional handover condition;
a third conditional handover condition is relaxed so that the serving cell is allowed to become worse than a first threshold and a neighbor cell is allowed to become better than a second threshold in order to meet the third conditional handover condition; or
dropping or shortening requirements related to time-to-trigger of a mobility event; or
dropping or reducing requirements related to a radio signal power level.

Example 45. The apparatus according to any one of examples 35 to 44, wherein the modifying the mobility procedures for the user equipment that is in a connected state comprises one or more of the following:
starting a radio link failure timer without waiting for a trigger, indicating a number of times an out-of-synchronization indication has been received, to meet a maximum configured value;
starting a connection recover timer and skipping actions related to radio link failure;
skipping sending of a radio link failure report;
excluding one or more cells associated to a current satellite from measurements for cell selection for a conditional handover; or
modifying one or more conditional handover configurations used for the conditional handover.

Example 46. The apparatus according to any one of examples 35 to 45, wherein the modifying the mobility procedures for the user equipment that is in a connected state is performed in order to delay detection of a possible radio link failure until a conditional handover can be considered according to the one or more time-based conditional handover event triggers.

Example 47. The apparatus according to any one of examples 35 to 46, wherein the apparatus is performed in one of a terrestrial network or a non-terrestrial network.

Example 48. The apparatus according to any one of examples 35 to 47, wherein at least one time-based conditional handover event trigger is defined as a distance-based condition to the serving cell, to a neighbor cell, or to both the serving and neighbor cell that can be mapped by the user equipment to a point in time by using orbital information of a moving satellite, movement information of the user equipment, or both the orbital information and the movement information.

Example 49. The apparatus according to any one of examples 35 to 48, wherein modifying the mobility procedures for the user equipment that is in the connected state comprises modifying one or more of the following: radio link failure procedures; re-establishment procedures; or handover configuration.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1B. A computer-readable medium may comprise a computer-readable storage medium (e.g., memories 125 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
5G fifth generation
AMF access and mobility management function
BBU base band unit
CHO conditional handover
CU central unit
DL downlink
DRB data radio bearer
DU distributed unit
eMTC enhanced Machine Type Communication
eNB (or eNodeB) evolved Node B (e.g., an LTE base station)
gNB (or gNodeB) base station for 5G/NR
GNSS global navigation satellite system
GSO geo-synchronous orbit
HO handover
I/F interface
IoT Internet of things
LEO low-earth orbit
LTE long term evolution
MAC medium access control
MME mobility management entity
ng or NG next generation
NGSO non-geo-stationary satellite
NR new radio
NTN non-terrestrial network
N/W or NW network
PCell primary cell, also called a serving cell
RAN radio access network
Rel release
RLC radio link control
RLF radio link failure
RLM RS radio link monitoring reference signal
RRH remote radio head
RRC radio resource control
RSRP reference signal received power
RTT round-trip time
RU radio unit
Rx receiver
SGW serving gateway
SIB system information block
SMF session management function
Tx transmitter
UE user equipment (e.g., a wireless, typically mobile device)
UI user interface
UL uplink (UE to network)
UPF user plane function

1. A method, comprising:
at a user equipment in wireless communication with a serving cell in a wireless network, the user equipment being configured with one or more time-based conditional handover event triggers, receiving by the user equipment indication that the serving cell will be turning off;
determining, by the user equipment, relative timing of the one or more time-based conditional handover event triggers and timing based on the indication of the serving cell turning off;
determining, by the user equipment, whether the relative timing meets one or more criteria; and
modifying, by the user equipment based on the relative timing meeting the one or more criteria, mobility procedures for the user equipment that is in a connected state.

2. An apparatus, comprising means for performing:
at a user equipment in wireless communication with a serving cell in a wireless network, the user equipment being configured with one or more time-based conditional handover event triggers, receiving by the user equipment indication that the serving cell will be turning off;
determining, by the user equipment, relative timing of the one or more time-based conditional handover event triggers and timing based on the indication of the serving cell turning off;
determining, by the user equipment, whether the relative timing meets one or more criteria; and
modifying, by the user equipment based on the relative timing meeting the one or more criteria, mobility procedures for the user equipment that is in a connected state.

3. The apparatus according to claim 2, wherein:
the one or more time-based conditional handover event triggers at least define a time window within which the handover from the serving cell to a target cell is allowed to occur; and
the determining whether the relative timing meets one or more criteria determines the relative timing meets the one or more criteria because a starting time of the time window is later than the timing based on the indication of the serving cell turning off.

4. The apparatus according to claim 2, wherein:
the one or more time-based conditional handover event triggers at least define a time window within which the handover from the serving cell to a target cell is allowed to occur; and
the determining whether the relative timing meets one or more criteria determines the relative timing meets the one or more criteria because a starting time of the time window is earlier than the timing based on the indication of the serving cell turning off, and an ending time of the time window is later than the timing based on the indication of the serving cell turning off.

5. The apparatus according to claim 3, wherein modifying the mobility procedures for the user equipment that is in a connected state comprises adding a waiting time to when a radio link failure procedure for detection of a radio link failure is to be started so a start of the radio link failure procedure is delayed at least by the waiting time.

6. The apparatus according to claim 5, wherein the waiting time is different when an ending time of the time window is later than the timing based on the indication of the serving cell turning off.

7. The apparatus according to claim 5, wherein the waiting time comprises a time added to a start of a timer, the expiration of which indicates a radio link failure, or a time added to actions related to a radio link failure declaration, after the timer is expired.

8. The apparatus according to claim 5, wherein the waiting time is a point in time that is calculated from a starting time of the time window, an ending time of the time window, or the timing based on the indication of the serving cell turning off, or is a time configured by the network or hard-coded.

9. The apparatus according to claim 3, wherein one or more time-based conditional handover event triggers comprise a starting time of the time window and duration of the time window.

10. The apparatus according to claim 2, wherein the one or more time-based conditional handover event triggers have corresponding conditional radio triggers used for conditional handover, and wherein the modifying the mobility procedures for the user equipment that is in a connected state comprises relaxing radio conditions from an initial condition to a relaxed condition for conditional radio triggers used after the timing based on the indication of the serving cell turning off has occurred.

11. The apparatus according to claim 10, wherein the relaxing radio conditions comprise one of the following:
a first conditional handover condition is relaxed so that a neighbor cell is allowed to become an offset better in radio conditions than the serving cell in order to meet the first conditional handover condition;
a second conditional handover condition is relaxed so that a neighbor cell is allowed to become better in radio conditions than a threshold in order to meet the second conditional handover condition;
a third conditional handover condition is relaxed so that the serving cell is allowed to become worse than a first threshold and a neighbor cell is allowed to become better than a second threshold in order to meet the third conditional handover condition; or
dropping or shortening requirements related to time-to-trigger of a mobility event; or
dropping or reducing requirements related to a radio signal power level.

12. The apparatus according to claim 2, wherein the modifying the mobility procedures for the user equipment that is in a connected state comprises one or more of the following:
starting a radio link failure timer without waiting for a trigger, indicating a number of times an out-of-synchronization indication has been received, to meet a maximum configured value;
starting a connection recover timer and skipping actions related to radio link failure;
skipping sending of a radio link failure report;
excluding one or more cells associated to a current satellite from measurements for cell selection for a conditional handover; or
modifying one or more conditional handover configurations used for the conditional handover.

13. The apparatus according to claim 2, wherein the modifying the mobility procedures for the user equipment that is in a connected state is performed in order to delay detection of a possible radio link failure until a conditional handover can be considered according to the one or more time-based conditional handover event triggers.

14. The apparatus according to claim 2, wherein the apparatus is performed in one of a terrestrial network or a non-terrestrial network.

15. The apparatus according to claim 2, wherein at least one time-based conditional handover event trigger is defined as a distance-based condition to the serving cell, to a neighbor cell, or to both the serving and neighbor cell that can be mapped by the user equipment to a point in time by using orbital information of a moving satellite, movement information of the user equipment, or both the orbital information and the movement information.

16. The apparatus according to claim 2, wherein modifying the mobility procedures for the user equipment that is in the connected state comprises modifying one or more of the following: radio link failure procedures; re-establishment procedures; or handover configuration.
